(19) United States
(12) Patent Application Publication
(10) Pub. No.: US 2002/0167655 A1
(43) Pub. Date: Nov. 14, 2002

(54) Image integration and multiple laser source projection

(76) Inventors: Melvin H. Friedman, Alexandria, VA (US); John M. Hall, Alexandria, VA (US)

Correspondence Address: INTELLECTUAL PROPERTY DIVISION, AMSTEL LG P NVEO, 10225 BURBECK RD, FORT BELVOIR, VA, 22060-5806, US

(21) Appl. No.: 09/842,146

(22) Filed: Apr. 26, 2001

(51) Int. Cl. G01J 1/00

(52) U.S. Cl. 356/121

(57) ABSTRACT

An apparatus and technique for sensor signal to noise ratio enhancement obtained by co-adding multiple identical images on an electro-optical sensor focal plane. An apparatus and technique for multiple laser source projection onto a target by use of laser diode arrays which are collimated and then diverted to simultaneously illuminate a target.

### BACKGROUND OF THE INVENTION

1. Field of the Invention

The present invention generally relates to improving image signal to noise ratio and laser illuminator techniques. More specifically, the present invention relates to single frame multiple image integration and in combination with multiple source laser projection.

2. Description of Prior Art

Automatic target recognition (ATR) is a desired technique for use in weapon systems to be used in the “digital battlefield” of the twenty-first century. No system presently available allows for the combination of the various functions required for providing a fully functional practical ATR system. Factors that are of importance include: signal to noise ratio, power projected by a laser designator on a target, and coding information projected by a laser designator on a target.

Most modern imaging sensors are designed to meet at least three performance parameters, including a minimum field of view, a minimum angular resolution, and a signal-to-noise contrast function which describes the system's ability to discern target contrast between a traget and its background. As a general rule, a sensor's signal-to-noise ratio (SNR) can be improved by fabricating more sensitive detectors or increasing the optical aperture to collect more light. For many imaging systems, the fields of view, optical apertures, and detector sensitivities are optimized for best performance under standard or most frequent conditions. In actual use, however, occasions will arise when an extra “boost” is needed to enhance certain aspects of image quality. Field of view and angular resolution can be easily modified using zoom optics or adding telescope lenses. Enhancements to the SNR are more difficult, however, because most detectors can not simply “boost” their signal levels without also increasing the noise and many optical systems will have practical limits on the allowed aperture dimensions and overall design complexity. Searching techniques of the prior art is done in the wide field of view and then to get a better look at the target the operator switches or zooms to the narrow field of view. In imagers made up to this point, this puts more pixels on the target but can result in an increased f/# which results in the pixels having more noise.

One method to enhance the SNR is to provide more detector elements to view the same image. This is achievable for linear scanning systems by aligning two or more identical linear arrays of detectors parallel. The scanned image passes quickly over each detector, and the electronic signals from identical points in the scenery as viewed by each detector are then summed. This is often called “time delayed integration” (TDI), because there is a slight time delay as the image sweeps from one detector to the next. TDI operates in synchronization with the scan rate, and is considered “real-time.” This technique requires complex timing on the array readout, and obviously involves more complicated manufacturing processes to include the extra arrays. TDI is not practical for a two-dimensional staring array because TDI relies upon some method of scanning the scene.

Another technique common to both one-dimensional array scanning and two-dimensional staring sensor systems is to electronically add segments of imagery gathered from the same object or scene over time. Entire two-dimensional images are stored in an electronic frame memory, and then can be added together with specific image processing to enhance the SNR. This temporal integration can enable an increase in SNR of approximately the square-root of the number of image segments integrated. The problem with this technique is that neither the sensor or target can be in relative motion, otherwise the shifts of object location on the focal plane over time will smear out details as frames of imagery are summed over time.

Most modern target designators utilize a specific wavelength assigned for a specific target. Designation becomes more complex as multiple random factors and multiple targets cause a weapon to miss the intended target. Extremely short time intervals utilized for an execution also complicate designation. It is not until an execution sequence is already in progress that it is precisely determined what is the target. Two weapon systems have also been known to attack the same target, which can lead to wasteful battlefield resources. For imaging sensors, illumination can be an ideal technique, but has not been practically demonstrated in the prior art.

The prior art involved in laser diode or other multiple-source illuminators usually involves individual sets of optics, which collimate a finite array of diode emitters. The larger the size of the emitter array, the greater the divergence angle of the exiting beam. This places a practical limitation on the output power that can be directed at a small target some distance away from the illuminator. The optics for the diodes themselves often possesses anamorphic optical powers to accommodate the varying divergences of diode output in the horizontal and vertical directions, which lead to distortion problems.

While the prior art has reported using sensor resolution enhancement and target designation, none have established a basis for a specific apparatus and technique that is dedicated to the task of resolving the particular problem at hand. What is needed in this instance is an apparatus and technique for improving sensor signal to noise ratio and in combination, a target designator.

### SUMMARY OF THE INVENTION

It is therefore one object of the invention to provide an apparatus and technique for improving sensor signal to noise ratio and in combination, a target designator.

According to the invention, there is disclosed an apparatus and technique for sensor resolution enhancement for obtaining multiple identical imagery superimposed onto the focal plane of a electro-optical sensor system. A means for diverting identical incoming light rays to converge onto an optical sensor pupil is used. An optical collimating assembly collimates light input from the optical sensor pupil onward to a focal plane. A focal plane array at the focal plane accepts the collimated light rays. The incoming light rays from a single image is thus redirected as multiple light rays delivering multiple identical imagery superimposed onto the focal plane. An increased signal-to-noise ratio further includes producing multiple detector signals from corresponding focal plane array detectors and calculating spatial integration of a given number of said multiple detector signals. There is an increase of total detector signal strength on the order of said given number.

There is also disclosed an apparatus and technique for laser source projection onto a target by use of a laser diode array for emitting multiple laser diode emissions which are collimated then diverted to simultaneously illuminate a target. The multiple laser diode emissions can further comprise emissions at multiple wavelengths such that the target is illuminated at multiple wavelengths simultaneously.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is an optical ray trace for a faceted prism utilized as an optical diverter assembly of the invention.

FIG. 2 is an optical ray trace of the invention for target designation function.

FIG. 3 is a detector field of view layout of the preferred embodiment.

FIG. 4 is a flow chart of the steps to calculate spatial integration.

FIG. 5 is a side view diagram of a multi-mode infrared search and track (IRS&T) panning sensor and designator system utilized as a system preferred embodiment.

### DETAILED DESCRIPTION OF A PREFERRED EMBODIMENT OF THE INVENTION

The invention described herein provides an apparatus and technique for improving sensor signal to noise ratio and in combination a target designator. The sensor may be an electro-optical imaging sensor or an IRS&T which displays distant targets as a moving point. There is described herein a sensor resolution enhancement that optically projects several identical narrow fields of view onto a system focal plane that accepts a wider, two-dimensional field of view. This can be useful for any visible, ultraviolet, or infra-red sensor system. This can be used to provide real-time single frame image integration to improve a signal-to-noise-ratio of a sensor. The same optical geometry that is used to divide the wide field of view of an imaging system can also be used in reverse to align the photon output from a two-dimensional array of photon emitter diodes so as to illuminate a distant target with increased brightness. This arrangement will work best if the collimating optics provide a telecentric focal plane on the emitter array.

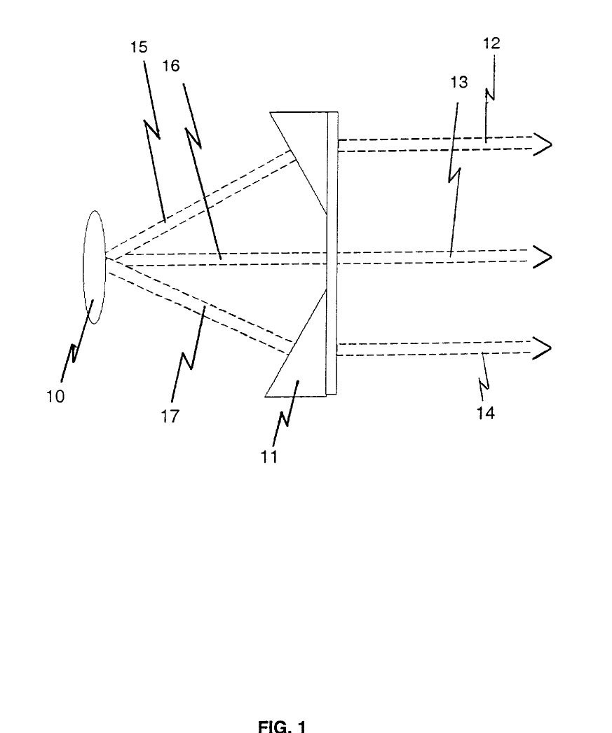

Referring now to the drawings, and more particularly to FIG. 1, there is shown an optical ray trace for a faceted prism utilized as one embodiment for the means for optical diversion utilized in the invention. It is understood that the invention is not limited to the number of facets utilized in the preferred embodiments. Lens aperture 10 is the end lens aperture of an optical collimating assembly of the invention, and faceted prism 11 is utilized. It is understood that a folded mirror array could be utilized alternatively as the means for optical diversion. As a sensor resolution enhancement, light rays 12, 13 and 14 are incoming from a given location in space of a single image that is then shown as re-directed through faceted prism 11 as light rays 15, 16 and 17 to be collimated onto a focal plane array, thus delivering multiple imagery that is superimposed to enhance signal-to-noise ratio.

The invention is intended for use with a wide field of view optical system. The reason for this is that as the field of view widens, with a fixed number of facets, the separation between the faceted lens and the first lens of the optical collimator assembly gets smaller which permits a more compact design. The invention allows rapid panning, tracking of fast objects, and mobility of the sensor without resolution losses due to temporal image smearing. The invention is also intended for use primarily in situations where the target covers a small fraction of the field of view but the target cannot be seen clearly because of noise on target and adjacent background pixels due to an inadequate number of source photons.

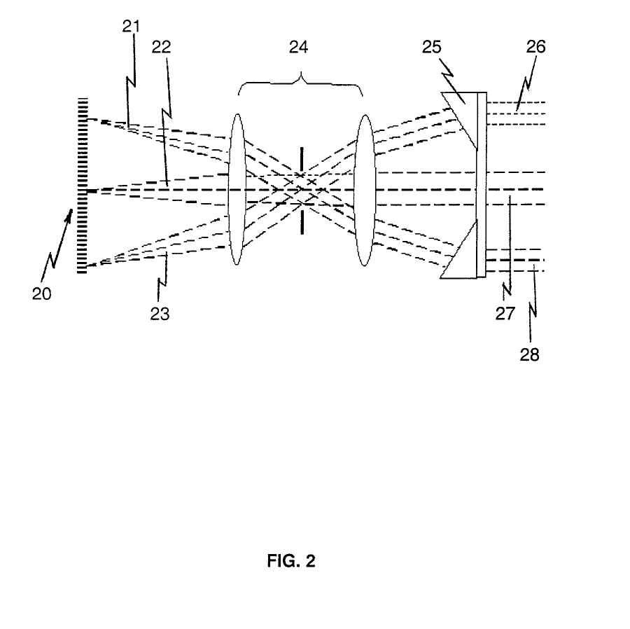

FIG. 2 is an optical ray trace of the invention for target designation function of the invention. Laser diode array 20 emits ray bundles 21, 22 and 23 that are collimated by optics assembly 24. Collimated light ray bundles are then diverted by element 25 as the means for optical diversion. From element 25 there is output parallel ray bundles 26, 27 and 28 that allows for a target to be illuminated simultaneously by all ray bundles. In the preferred embodiment for the target designator mode described an optical layout utilizing six refracting hexagonal prisms and a central hexagonal window enables a target to be illuminated by seven laser diodes simultaneously. It is understood that the inevtion is not limted to the number of laser diodes utilized.

As a preferred embodiment for target designation, at least seven laser diodes with a telecentric projection lens and a prism system can be used to illuminate a distant target with at least seven times the radiation possible with a single laser. The prism facets function to make the rays parallel to the optical axis so that each bundle of rays from the laser diode illuminates the target. If the array of diodes each operate at its own wavelength, there is achieved to utilize several wavelengths simultaneously allowing several sensors, each operating in their own wavelength band, to determine which target is designated. When selectively utilizing several wavelengths at will (accomplished by either turning on or turning off the diode) this allow signals from several laser designators operating simultaneously to be distinguished from one another. The emitters will be collimated efficiently as long as the divergence cone angle of the diodes does not exceed the F# cone of the optics. Telecentric optics would work best for this embodiment.

By using multiple wavelengths the person designating the target can code the wavelengths for a particular weapon system or can use wavelengths to designate a class of target. For example: λ₁ can be used for armored personnel carrier, λ₂ can be used for trucks and the combination (λ₁,λ₂) can be used to designate a tank. Alternately weapon system 1 can hone in on targets designated with wavelength λ₁, weapon system 2 can hone in on targets designated with wavelength λ₂ and weapon system 3 can home in on targets designated with wavelength λ₁ and λ₂. Of course with several facets, there are several wavelengths and many more combinations that can be used to coordinate specific weapon systems with specific target designators.

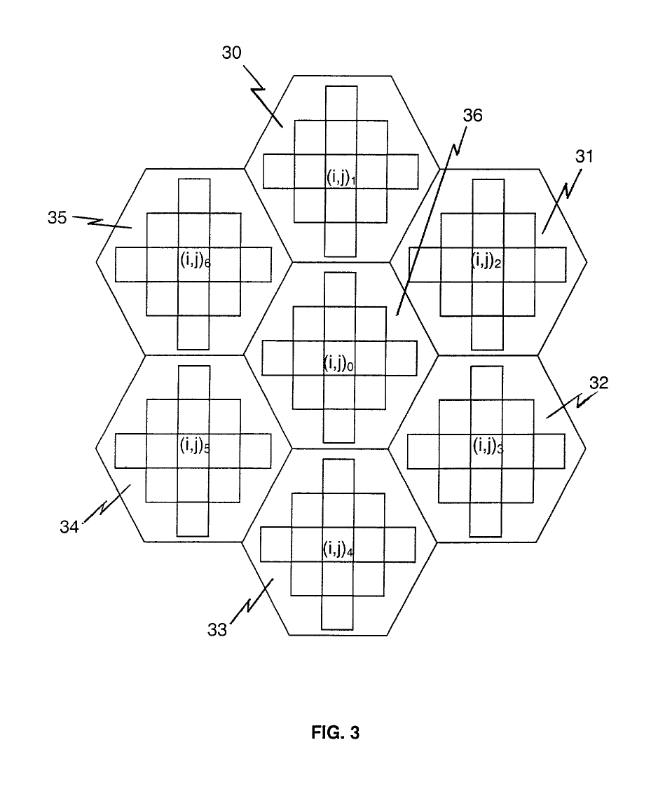

FIG. 3 is a detector field of view layout of the preferred embodiment. Facets 30-35 and central facet 36 are shown as hexagonal shape that approximately matches the shape of a circular entrance aperture. For simplicity of description, detectors are shown are square with a 100 percent fill factor. It is understood that detectors with other shapes and with a lesser fill factor may be used. The border shape of the individual pictures that tile the detector plane is identical to the facet shape. In a preferred embodiment, each facet should be large enough so as not to adversely effect the diffraction limit originally set by the optical system without the facets. This means that the aperture stop for the original optical system will be unchanged by adding the facets. The shape of central facet 36 should have a size and shape large enough to circumscribes the aperture stop. To achieve a signal to noise ratio improvement of n, the frontal area of the faceted optical element will have an area approximately n² the area of the aperture stop. In a system where facet shape is chosen to match the shape of the target, the frontal area of the faceted optical element will exceed n² the area of the aperture stop. Although the preferred embodiment has an optical arrangement with six hexagonal facets arranged around a hexagonal aperature, the number of facets and the shape of the facet used can be chosen to get an increased signal to noise ratio (with a decreased field of view).

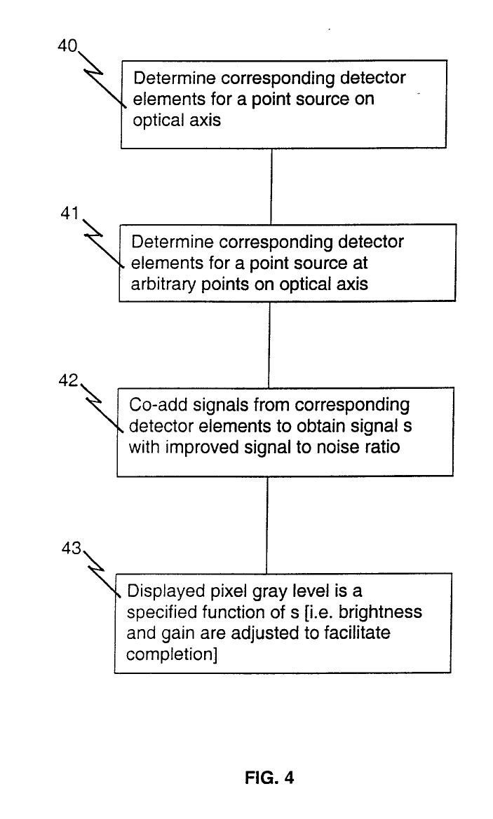

FIG. 4 is a flow chart of the steps to calculate spatial integration and thus obtain greater signal-to-noise ratio. There is acquired n identical images with an area field of view reduced by 1/n the original field of view. In the generalized description that follows for simplicity of exposition, a staring array will be assumed. However, the method to be described applies equally well to a scanning system. The sensor utilized can be in either the single frame integration mode, or in the standard unaltered mode. It is assumed that the central facet has a hexagonal shape and is surrounded by six other hexagons. For the steps given here, n is seven and the shape of the facet is hexagonal.

As the first step, shown in FIG. 4 as step 40, there is determined the corresponding detector elements for a source on the optical axis. A point source of light on the optical axis is placed at a long distance from the sensor. The point source of light need not be real. It can be a virtual light source used in a ray trace calculation. After traversing the optical system, the ray from the point source intersects the focal plane at the optical axis and at six other points. Let (i, j)₀ denote the optical axis intersects the focal plane and let (i, j)ₖ with k=1, . . . 6 denote the six other locations where rays from the point source intersect the focal plane. Detectors are centered at focal plane positions (i, j)ₖ with k=0, 1, . . . 6. These are the seven corresponding detectors for a point on the optical axis.

Step 41 is determining corresponding detector elements for source points not on the optical axis. Suppose the detectors in the window of the central hexagonal facet are arranged in a Cartesian grid with a 100% fill factor about the point (i, j)₀ as shown in FIG. 3. The extension to the case where the detectors in the window of the central facet are arranged in some other manner will be obvious to those skilled in the art. The extension to the case where the fill factor is less than 100%, complicates the notation but will be obvious to those skilled in the art. Let (i+m, j+n)₀ denote the pixel m units to the right and n units above (i, j)₀ but within the central hexagonal window. Adjust the point source of light so that rays from it fall in the center of detector (i+1, j)₀. Then the ray of light will also fall at focal plane locations (i+1, j)ₖ with k=1, . . . 6. The detector array is designed so that detectors are centered at locations (i+1, j)ₖ with a shape and orientation identical to the detector at (i+1, j)₀. These are the six detectors which correspond to the detector centered at (i+1, j)₀. The process is repeated for all detector elements in the central hexagonal window. In this way for each detector element in the central hexagonal window, there are six corresponding detectors in the surrounding hexagonal windows.

Step 42 is co-adding signals from corresponding detectors. The detectors are designed so that in the absence of noise, the response from each detector is identical. The signal s(m, n) assigned to location (i+m, j+n)₀ is readily computed:

$$s ( m , n ) = \frac{1}{7} {\sum }_{k = 0}^{6} {s ( m , n )}_{k} \qquad ( 1 )$$

In equation 1, s(m, n)ₖ is the signal from the detector at location (i+m, j+n)ₖ.

Step 43 is a determination of the display gray level. The signal s(m, n) is used to determine the display gray level:

g(m, n)=a₀s(m, n)+b₀ (2)

In equation 2, g (m, n) corresponds to the display gray level and a₀ and b₀ are constants that depend on the gain and brightness controls. Other transformations of s (m, n) to gray levels may also be used.

In the preferred embodiment of the technique, there is utilized seven field of view. When the imaging system is directed toward a point source of light and moved so that the point source of light illuminates a single detector in the detector array sector 0, then single detectors in the detector array sectors 1, 2 . . . 6 will also be illuminated. This defines one set of corresponding detectors in the detector array. The imaging system is designed so that each detector in sector 0 of the detector array has corresponding detectors in sections 1, 2, . . . 6. In use, during a single frame, signals from each of the corresponding detectors are co-added. In this case the signal will be seven times stronger and it is expected that the noise will be the square root of seven stronger yielding an improvement by the square root of seven in the signal to noise ratio.

The process of co-adding images is facilitated if the detectors in the detectors have appropriate positions in the detector array. In a preferred embodiment, detectors illuminated by radiation, which come through the central facet, are positioned in a square lattice with a constant pitch in two orthogonal directions. This will be termed the reference lattice. To determine where detectors associated with the other facets should be positioned, put a point source at a distant location so that radiation passing through the central facet falls directly on detector i in the reference lattice. Radiation from the point source passing through each of the other facets will intersect the image plane at some point. That is the corresponding detector location for that facet corresponding to detector i in the reference lattice. This process is repeated for each detector in the reference lattice.

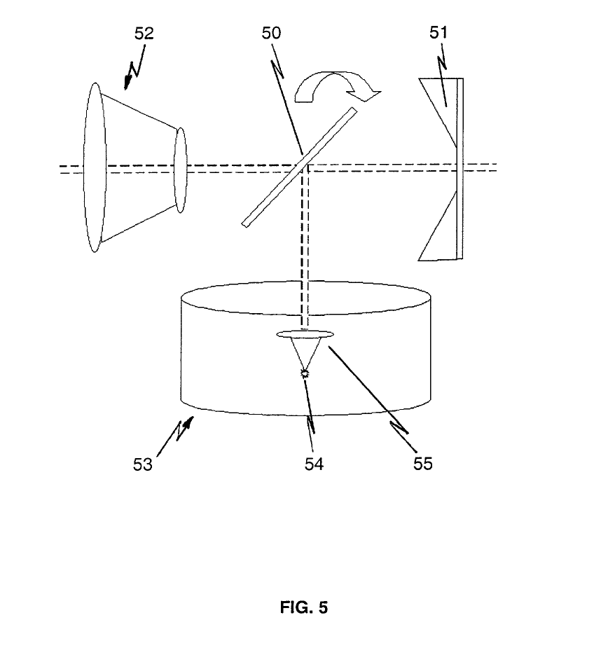

FIG. 5 is a side view diagram of a multi-mode infrared search and track (IRS&T) panning sensor and designator system utilized as a system preferred embodiment. Mirror 50 is utilized for switching between beam steering device 51 and IR telescope 52. In the preferred embodiment, a simple 90 degree fold mirror is utilized as mirror 50. Beam stering device 51 forms a window, and prismatic elements will bend only the horizontal FOV, leaving the vertical FOV unaffected. IR telescope 52 allows for optional viewing of the target. Sensor assembly 53 includes sensor head 54, as a rotating head which rotates about collomator optics 55. This enables the sensor assembly to rotate 360 degrees and use the sensor as a line scanner with an increased signal-to-noise-ratio (SNR) where a large vertical field of view and high SNR is achieved.

While this invention has been described in terms of preferred embodiment consisting of an apparatus and technique, those skilled in the art will recognize that the invention can be practiced with modification within the spirit and scope of the appended claims.

Having thus described our invention, what we claim as new and desire to secure by Letters Patent is as follows:

1. An apparatus for sensor resolution enhancement for obtaining multiple identical imagery superimposed onto the focal plane of a electro-optical sensor system comprising:
a means for diverting identical incoming light rays to converge onto an optical sensor pupil;
an optical collimating assembly for collimating light input from said optical sensor pupil onward to a focal plane, whereby incoming light rays from a single image is redirected as multiple light rays delivering multiple identical imagery superimposed onto said focal plane.

2. The apparatus of claim 1 wherein said means for diverting identical incoming light rays is a faceted prism.

3. An apparatus for laser source projection onto a target comprising:
a laser diode array for emitting multiple laser diode emissions;
an optical collimating assembly for collimating said multiple laser diode emissions;
a means for diverting all said collimated laser diode emissions, whereby the multiple laser diode emissions are all parallel to the optical axis thus simultaneously illuminating the target.

4. The apparatus of claim 3 wherein for diverting said multiple laser diode emissions is a faceted prism.

5. A technique for sensor resolution enhancement for obtaining multiple identical imagery superimposed onto the focal plane of a electro-optical sensor system comprising:
diverting identical incoming light rays to converge onto an optical sensor pupil;
collimating light input from said optical sensor pupil;
accepting said collimated light rays onto a focal plane, whereby incoming light rays from a single image is redirected as multiple light rays delivering multiple imagery superimposed onto the focal plane.

6. The technique of claim 5 wherein there is achieved an increased signal-to-noise ratio further including the steps of:
producing multiple detector signals from corresponding focal plane array detectors resulting from impact of said collimated light rays upon a FPA at said focal plane;
calculating spatial integration of a given number of said multiple detector signals, whereby there is an increase of total detector signal strength on the order of said given number.

7. A technique for laser source projection onto a target comprising:
emitting multiple laser diode emissions;
collimating said multiple laser diode emissions;
diverting all said collimated laser diode emissions, whereby said collimated multiple laser diode emissions are all parallel to the optical axis thus simultaneously illuminating the target.

8. The technique of claim 7 wherein said multiple laser diode emissions further comprise emissions at multiple wavelengths such that the target is illuminated at multiple wavelengths simultaneously.
